(19) United States
(12) Patent Application Publication
(10) Pub. No.: US 2025/0005708 A1
(43) Pub. Date: Jan. 2, 2025

(54) Image Upscaling Apparatus and Method

(71) Applicant: Sony Interactive Entertainment Deutschland GmbH, Neu-Isenburg (DE)

(72) Inventor: Marcos Conde, Wuerzburg (DE)

(73) Assignee: Sony Interactive Entertainment Deutschland GmbH, Neu-Isenburg (DE)

(21) Appl. No.: 18/758,894

(22) Filed: Jun. 28, 2024

(30) Foreign Application Priority Data
Jun. 29, 2023 (GB) 2309853.6

(51) Int. Cl. G06T 3/4053; G06T 5/20; G06V 10/44

(52) U.S. Cl. CPC G06T 3/4053; G06T 5/20; G06V 10/44; G06T 2207/20084

(57) ABSTRACT

A method of image upscaling comprises the steps of obtaining an input image at a first resolution, pre-processing the input image to generate pre-processed input data, extracting deep features based upon the pre-processed input data using one or more convolutional neural network ‘CNN’ blocks, and generating as an output image an upscaled version of the input image at a second resolution higher than the first resolution based upon the extracted deep features, wherein the input image has a data structure comprising a pixel count ‘C’ and a channel depth ‘d’, and the pre-processing step comprises an inverse pixel shuffling ‘pixel unshuffle’ that reduces the spatial resolution of the data structure whilst increasing the channel depth of the data structure, by reallocating pixel data of one or more first subsets of pixels of the input image to additional channel data of a second subset of pixels of the input image to generate pre-processed input data with a data structure comprising a pixel count of C/R and a channel depth of d×R, where R is a degree of spatial reduction.

### CROSS-REFERENCE TO RELATED APPLICATIONS

The present application claims priority from Great Britain Patent Application No. 2309853.6, filed Jun. 29, 2023, all of which is hereby incorporated herein by reference.

### BACKGROUND OF THE INVENTION

### Field of the Invention

The present application relates to an apparatus and method of image upscaling.

### Description of the Prior Art

So-called Super-Resolution (also known as Upscaling or Upscaling) is a fundamental problem in computer vision and computer graphics.

Over the past few years, high-definition videos and images in 720p (HD), 1080p (FHD), and 4 K (UHD) resolution have become standard. While higher resolutions offer improved visual quality for users, they pose a significant challenge for videogames systems to achieve at a target frame rate. One solution is to render or otherwise generate an image at a resolution that enables the target frame rate, and then perform real-time super-resolution. However, this is also difficult to achieve within the target frame rate on commercial GPUs, particularly when the GPU is typically also performing the original rendering as well.

The present application seeks to address or mitigate this problem.

### SUMMARY OF THE INVENTION

Various aspects and features of the present invention are defined in the appended claims and within the text of the accompanying description.

In a first aspect, a method of image upscaling is provided in accordance with claim 1.

In another aspect, an image upscaling apparatus is provided in accordance with claim 12.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an entertainment device in accordance with embodiments of the present description.

FIG. 2 is a schematic diagram of an upscaling scheme known in the art.

FIG. 3 is a schematic diagram of an upscaling scheme in accordance with embodiments of the present description.

FIG. 4 is a schematic diagram of an inverse pixel shuffle or ‘pixel unshuffle’ scheme in accordance with embodiments of the present description.

FIGS. 5A and 5B are schematic diagrams comparing a feature extraction process known in the art and in accordance with embodiments of the present description.

FIGS. 6A and 6B are schematic diagrams of a basic and complex convolutional neural network ‘CNN’ block.

FIGS. 6C and 6D are schematic diagrams of CNN layers within training and inference CNN blocks in accordance with embodiments of the present description.

FIG. 6E is a schematic diagram of an inference CNN block in accordance with embodiments of the present description.

FIG. 7 is a flow diagram of a method of image upscaling in accordance with embodiments of the present description.

### DESCRIPTION OF THE EMBODIMENTS

An apparatus and method of image upscaling are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

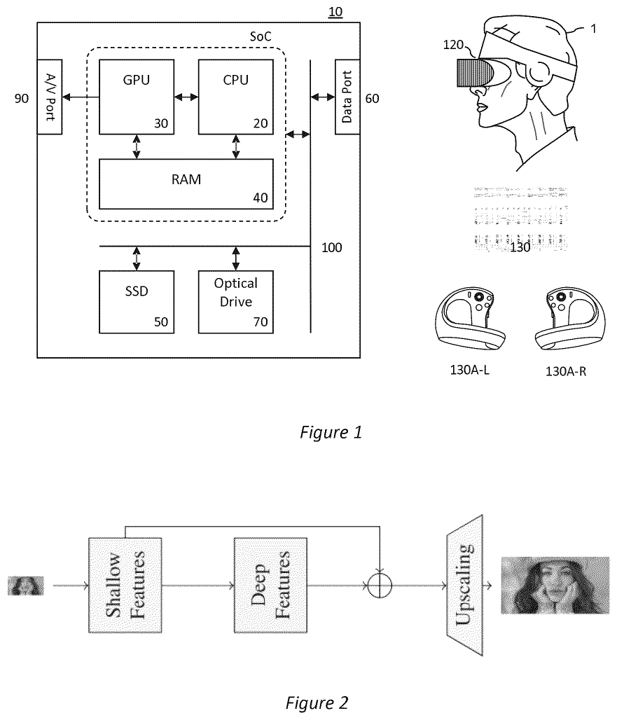

Referring now to the drawings, wherein like reference numerals designate identical or corresponding parts throughout the several views, FIG. 1 shows an example of an entertainment system 10, such as a computer or console like the Sony® PlayStation 5® (PS5).

The entertainment system 10 comprises a central processor 20. This may be a single or multi core processor, for example comprising eight cores as in the PS5. The entertainment system also comprises a graphical processing unit or GPU 30. The GPU can be physically separate to the CPU, or integrated with the CPU as a system on a chip (SoC) as in the PS5.

The entertainment device also comprises RAM 40, and may either have separate RAM for each of the CPU and GPU, or shared RAM as in the PS5. The or each RAM can be physically separate, or integrated as part of an SoC as in the PS5. Further storage is provided by a disk 50, either as an external or internal hard drive, or as an external solid state drive, or an internal solid state drive as in the PS5.

The entertainment device may transmit or receive data via one or more data ports 60, such as a USB port, Ethernet® port, Wi-Fi® port, Bluetooth® port or similar, as appropriate. It may also optionally receive data via an optical drive 70.

Audio/visual outputs from the entertainment device are typically provided through one or more A/V ports 90, or through one or more of the wired or wireless data ports 60.

An example of a device for displaying images output by the entertainment system is a head mounted display ‘HMD’ 120, such as the PlayStation VR 2 ‘PSVR2’, worn by a user 1.

Where components are not integrated, they may be connected as appropriate either by a dedicated data link or via a bus 100.

Interaction with the system is typically provided using one or more handheld controllers (130, 130A), such as the DualSense® controller (130) in the case of the PS5, and/or one or more VR controllers (130A-L,R) in the case of the HMD.

Referring now to FIG. 2, traditional methods of super resolution (‘SR’) or upscaling using a neural network start with shallow feature extraction, typically performed using a classical convolutional neural network ‘CNN’, followed by deep feature extraction and finally upscaling based on the deep features.

Embodiments of the present description provide an alternative SR or upscaling scheme.

In the following description we assume a desired high resolution (‘HR’) of 4K (3840×2160 pixels), from a low resolution (‘LR’) input image of 720p (1280×720 pixels); however it will be appreciated that the presently described scheme is not limited to either of these resolutions.

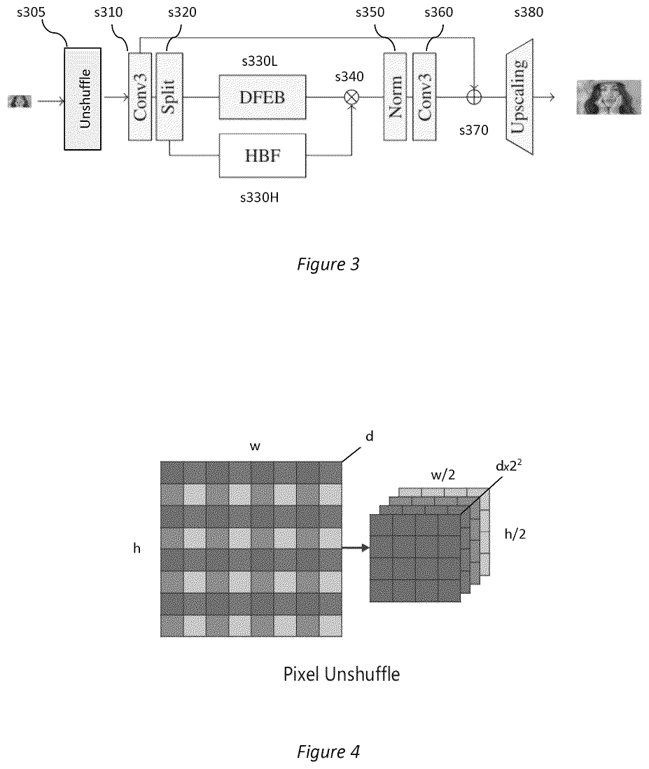

Referring now also to FIG. 3, embodiments of the present scheme comprise variants of the illustrated structure.
i. In an example embodiment, the pipeline begins with the standard resolution ‘SR’ input being subjected to an inverse pixel shuffle (‘pixel un-shuffle’) step s305, as described elsewhere herein.
ii. This is followed by shallow feature extraction using a convolutional layer with C filters (e.g. C=32 but can be any suitable number) at step s310, optionally followed by a GeLU non-linearity.
iii. Next, the high frequency ‘HF’ components are split in step s320 from the low frequency ‘LF’ components.
iv. The LF components enter a ‘DFEB’ deep feature extraction block in step s330L formed for example by concatenating convolutional layers, to obtain low frequency features.
v. Meanwhile the HF components enter an ‘HBF’ deep feature extraction block in step s330H that may be similar to the concatenated convolutional layers of the DFEB, but is not limited to this, to obtain high frequency features.
vi. The features from the DFEB and HBF blocks are then combined in step s340.
vii. A LayerNorm is typically added in step s350, optionally followed by another convolution step s360,
viii. An upscaled image at the desired output resolution is generated in step s380, typically using a pixel shuffle, but alternatively or in addition any suitable scheme.

Optionally steps vi and vii can be swapped. Similarly, step iii. can optionally precede step ii., so that the shallow feature extraction only supplies the DFEB block. Other rearrangements (or deletions) of one or more of the above steps will be apparent to the skilled person.

The scheme is not restricted to any particular type or types of convolutional block, and any suitable CNN or convolutional block may be envisaged.

Hence the scheme comprises one or more of the following notable features:
i. use of a ‘pixel un-shuffle’, which improves the performance of the convolutional neural networks, particularly but not exclusively in the deep feature extraction phase as described elsewhere herein;
ii. separate deep feature extraction pipelines for low and high frequency features, enabling separate and potentially different processing, and computational efficiencies and performance, for different aspects of the data; and
iii. in addition, a reduction in the computational steps required for one or more layers of a convolutional neural network during inference, as opposed to during training, is provided as described elsewhere herein.

### Pixel Un-Shuffle

Given an input image with for example three channels (e.g. RGB, but in principle other schemes such as LAB may be considered), the data structure comprised within this image can be described as [h, w, d], i.e. having a height and width corresponding to the image resolution and a depth corresponding in this case to the three colour channels.

Referring now also to FIG. 4, in embodiments of the description it has been appreciated that an inverse pixel shuffle or ‘pixel un-shuffle’ as described herein can reconfigure the distribution of this data to improve the computational efficiency of a set of convolutional neural networks.

In general, pixel data of one or more first subsets of pixels of the input image are reallocated to additional channel data of a second subset of pixels of the input image; in FIG. 4, three first subsets of pixels are reallocated to additional channel data of a second subset of pixels; in the case of FIG. 4, in each block of 4 pixels the pixel data of the first (top left) pixel is augmented with the pixel data of the other three pixels.

Thus the height and width of the data structure can be reduced whilst increasing the depth, for example to generate equivalent [h/2, w/2, 3×2²] or [h/4, w/4, 3×4²] [h/4, w/4, 48] data structures. The depth here is d×s² where d is 3 (for RGB) and s is the degree of spatial reduction or down sampling (in these examples, 2 or 4). Hence the results are [h/2, w/2, 12] and [h/4, w/4, 48]. Similarly [h/3, w/3, 3×3²] would give [h/3, w/3, 27], which may particularly suit a conversion from 720p to 4 k.

The above example assumes a square or symmetrical spatial reduction in the width and height dimensions, but the technique need not be limited to this. More generally it will be appreciated that an image having height h and width w will have a pixel count C=h×w. Consequently reallocating pixel data of one or more first subsets of pixels of the input image to additional channel data of a second subset of pixels of the input image (e.g. as shown in FIG. 4) will reduce the pixel count C by a factor R, where R is a degree of spatial reduction (in the above example, R=s² since the image was reduced to h/s, w/s), and increase the channel depth to d×R (again in the above example R=s²). Hence any possible decimation scheme may be used as desired and need not be symmetrical in height and width. For example h/4, w/3, d×12.

In any event, in effect this process creates a small ‘image’ or data structure where each ‘pixel’ or position on the h, w axes has many more channels than a simple RGB image. Hence in effect a counterintuitive preparatory step of the present spatial upscaling scheme is to spatially downscale the image whilst increasing the channel depth.

It will be appreciated that normal downsizing the spatial dimensions of the input image may reduce the required runtime for processing the image, but this would result in the loss of valuable details, which of course is undesirable for SR tasks that aim to recover previously lost information.

However, a pixel un-shuffle as described herein reduces the spatial dimensions by a factor of s, while increasing the channel dimension by a factor of s². This preserves the overall amount of information in the input data set whilst improving computational efficiency, as follows:

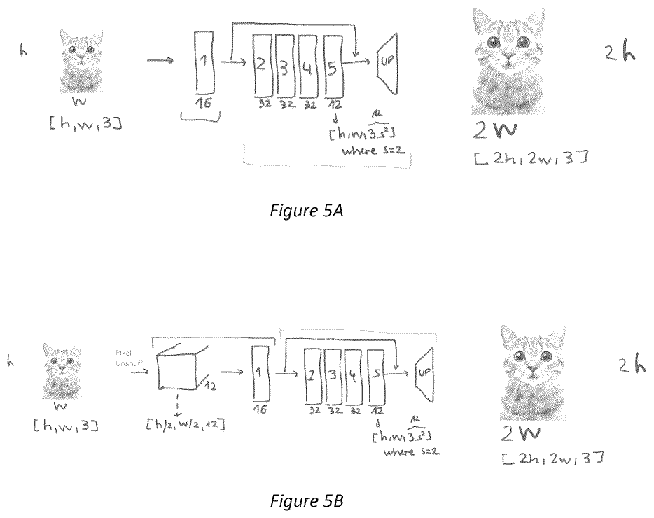

During for example deep feature extraction, successive layers of convolutional networks are used. FIGS. 5A and 5B illustrate 5 layers, with the number of channels (and corresponding filters) indicated below each block. Each convolution operation can be assumed to use 3×3 filters, although other filters (e.g. 5×5) can be used.

In FIG. 5A, for the example input image resolution of 1280×720 pixels then the data structure to which the first convolutional layer (layer 1) is applied is of dimensions [h,w,3]=[1280, 720, 3]. This first convolutional layer provides the shallow feature extraction of step s310.

In FIG. 5B, the input has been pixel unshuffled and so the data structure is [h/2, w/2,sx2²]=[640, 360, 12]. Again the first convolutional layer (layer 1) provides the shallow feature extraction of step s310.

The total number of input values is the same (approximately 2.8 million) but they are arranged differently.

As a result the computational cost of the first convolutional network layer is roughly the same for both approaches (a similar number of matrix multiplications), but processed in slightly different ways (FIG. 5B having 4× more multiplications per position for ¼ as many positions as in 5A). For FIG. 5B there is also the cost of the preceding pixel unshuffle process itself, but this is quite efficient.

However, the output of layer 1 is no longer an image, but a processed representation with typically 16 channels, for either kind of input (i.e. both in the case of FIG. 5A and also 5B). Consequently, convolution layers 2+ (in this case 2 to 5) can operate in the same manner for either approach. These layers (or respective instances thereof) provide the deep feature extraction of steps s330L,H.

However, there is then a benefit in because for FIG. 5A the data used by each of these convolution layers is [h, w, 16], whereas for the arrangement in 5B the data used by each convolution layer is now [h/2, w/2, 16]. As a result, the computational cost for the convolutional layers in the deep feature extraction process is reduced dramatically (e.g. in the order of 75%). Notably, the eventual quality of the upscaled images is not similarly reduced; an apparent redundancy in the 16 channel shallow feature output of the first layer in FIG. 5A is simply used more efficiently/reduced with the pixel unshuffled input for the the 16 channel shallow feature output of the first layer in FIG. 5B.

### Deep Feature Extraction

As noted previously, in embodiments of the description, in steps s330H and s330L, high-frequency features (e.g. edges and contours) are processed separately in step s330H (in a high frequency block ‘HBF’ in FIG. 3) to low-frequency features (deep feature extraction, general textures) processed in step in steps s330L (in a low frequency block ‘DFEB’ in FIG. 3).

The low-frequency features are typically processed as described previously herein within with respect to pixel unshuffling.

For the high frequency features, any suitable mechanism for extracting high frequency components from an image may be used, such as, in a non-limiting example, Sobel filters.

The high frequency features can also be processed using any suitable convolutional block structure for upscaling purposes, with any suitable choice of number of layers, filters per layer, and/or connections between layers. Optionally this can be substantially the same as for the low-frequency features.

The resulting high frequency features can be combined with the eventual output from the low-frequency block at step s340, by adding them to the output from the low frequency block or by applying a pixel-wise multiplication. Optionally the combination of outputs from the low and high frequency paths can instead be similarly combined after (parallel) upscaling, or just prior to (combined) upscaling.

In any case, the high frequency features can optionally be extracted before pixel unshuffling has been performed; the processing pipeline can then be entirely in parallel up to the re-merging of data at step s340, or later as described above. This may allow for the HF features to use or not use separate pixel-unshuffling, to use similar or different shallow feature extraction (e.g. with different channels, filters, layers, and/or connections between layers), and similarly to use similar or different deep feature extraction (e.g. with different channels, filters, or layers) to that of the low frequency features.

Alternatively, the high frequency features can be extracted after pixel unshuffling and shallow feature extraction has been performed; the HF features may then use similar or different deep feature extraction (e.g. with different channels, filters, layers, and/or connections between layers) to that of the low frequency features.

Alternatively again, the high frequency features can be extracted after pixel unshuffling, and then a shared convolution can be used to extract LF and HF shallow features (e.g. passing the HF and LF features through the same CNN sequentially rather than having separate CNNs for each pipeline); the HF features may then use similar or different deep feature extraction (e.g. with different channels, filters, layers, and/or connections between layers) to that of the low frequency features.

Advantageously one or more CNNs for each of these pipelines can thus better specialise in the features relevant to the low and high frequency aspects of the image data, and optionally can be structured differently as outlined above to facilitate this, thus improving overall performance.

Hence the approach of using separate paths for deep feature extraction may mean either path using, or not using, pixel-unshuffling first (though typically at least the low-frequency path uses this).

### Re-Parameterisation

Using the deep feature extraction stage as a non-limiting example, each ‘layer’ may comprise a standard 3×3 convolution (and typically a GeLU activation) repeated N times (e.g. 4 times for layers 2-5 of FIGS. 5A and 5B).

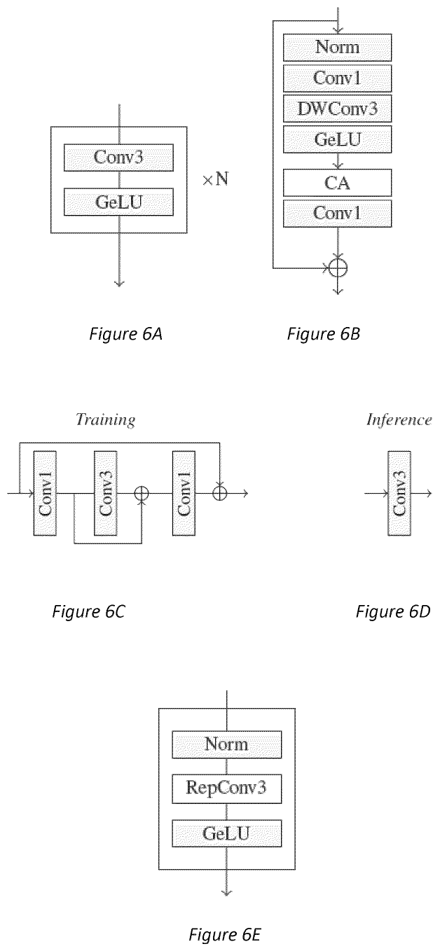

Such a basic block is shown in FIG. 6A.

The performance of such a block can be improved using a so-called NAFNet block, shown in FIG. 6B.

This comprises three convolutions typically followed by a GeLU non-linearity and an optional channel attention module CA.

Taking the depth-wise separable convolutions from this block alone, these are shown at FIG. 6C, which may be referred to as a re-parameterisable residual block ‘RRB’. As a non-limiting example the RRB expands the channel dimension C by a factor of f_{Exp}=2 with a 1×1 kernel convolution. Next, a 3×3 kernel convolution enhances the learned features in a higher dimensional space, followed by a final 1×1 kernel convolution that compresses the channels back to C, retaining only the most discriminative features. Short and long residual connections can facilitate feature propagation.

However, during inference (i.e. when performing upscaling or super-resolution) then as noted elsewhere herein it is desirable for the process to be as fast as possible with limited impact on image quality in order to achieve desirable frame rates.

Consequently whilst the above scheme may be used during training, in embodiments of the description the above three kernels are replaced with one 3×3 kernel for inference, as follows:

If the three kernels are defined as K1-K3, the trained kernels from K1 and K2 can be combined into K12 and both operations can be applied as a single 3×3 convolution (by associative property of the multiplication).

Then K12, a 3×3 convolution, can be combined with K3 (in the same way as before), ending up in K123, a single 3×3 convolution as shown in Figured 6D.

Consequently (and optionally dropping the channel attention module CA or using a more efficient version not shown), the NAFNet block shown in FIG. 6B can be replaced with a re-parameterised block as shown in FIG. 6E for actual inference. Here ‘RepConv3’ refers to a re-parameterised convolutional block of one layer.

This provides a simplified and computationally much more efficient processing block whilst gaining the performance benefits of the NAFNet block. Optionally here the normalisation may optionally be omitted, and/or the GeLU nonlinearity, depending on the nature of the convolutional block, and any upstream or downstream processing of the data that reduces or eliminates the need for these components.

It will be appreciated that this approach is not limited to NAFNet blocks or to the sequence of layers within the deep feature extraction block, but is applicable to any CNN block in the upscaling architecture where two or more CNNs used during training can be combined by virtue of the associative property of the multiplications.

Consequently the computational (and memory) overhead of these blocks is reduced at runtime for inference.

### Variants

A non-limiting list of variants include the following.
i. Notably, incorporating a pixel un-shuffle naively into an SR architecture can significantly reduce its efficiency, even if it does improve the reconstruction accuracy. However, to compensate for the loss of inference efficiency, it is optionally possible to squeeze the channel dimensions after the unshuffling process and then map them back after the output of the deep feature extraction block. This recovers the efficiency but loses information in the channel reduction.
   Consequently, it is preferable to optionally perform the pixel un-shuffle before performing the 3×3 convolution used for extracting shallow features so that it occurs after the image has been unshuffled, as illustrated for example in FIG. 3.
ii. As noted elsewhere herein, super-resolution upscaling according to the example system in FIG. 3 may use various combinations of pixel unshuffle, a separate high frequency branch, and one or more reparametrized CNN blocks. A particular list of options includes:
a. Pixel unshuffle before shallow feature extraction;
b. Low and high frequency branches sharing shallow feature extraction (either by splitting after, or re-using the CNN; and
c. Use of re-parameterised blocks for deep feature extraction
iii. Optionally one or more of the CNN models used within the upscaling system can be trained on specific content (for example by genre, by series, by title, or even by level/region within a single game if these are graphically distinct). Training material can be generated for example by the developers or during QA testing.

The system can thus for example have different sets of weights for different genres/titles/levels, and swap them in as needed for the game or part of game being played, as applicable.

### Training

High resolution images can be down-sampled (e.g. using bi-cubic down-sampling) to the lower resolution at which they will be input to the SR architecture when generated at the lower resolution at run time.

Alternatively, to avoid any differences between down sampling and native generation (e.g. aliasing effects not present in native generation), the images can be generated separately at the lower and target resolutions, ensuring that the images are being generated for the exact same scene and so correspond faithfully.

The lower resolution image can be used as a source of input data, and correspondingly the respective high resolution image can be used as a source of target data.

The upscaler (and hence the CNNs therein) may be trained on random crops of size 128×128 (as a non-exhaustive example) from the RGB image data of the lower resolution image. The crops may also be randoming rotated by 90, 180, 270 degrees and/or flipped horizontally and/or vertically (with the corresponding target being similarly pre-processed).

As a non-limiting example, a stochastic optimizer may be used to minimize the loss between the upscaled image output and the HR target for 100 epochs with the batch size set to 64 and an initial learning rate of 1e−3, along with a step scheduler with step size 20 and decay factor 0.5.

A non-limiting example optimiser is ADAM, an algorithm for first-order gradient-based optimization of stochastic objective functions, based on adaptive estimates of lower-order moments (see Diederik P Kingma and Jimmy Ba., Adam: A method for stochastic optimization. arXiv preprint arXiv: 1412.6980, 2014., incorporated herein by reference).

As noted elsewhere herein, the training may be specific to a genre of content, a series or title of content, or a specific scene/zone/level (whether for conventional media or for a videogame).

### SUMMARY

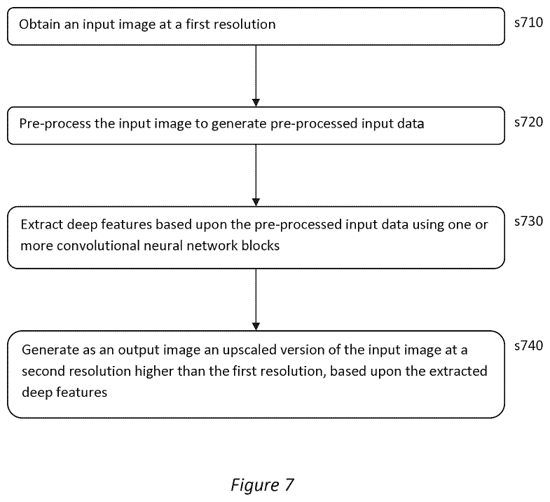

Turning now to FIG. 7, in a summary embodiment of the present description, a method of image upscaling, comprises the following steps.

In a first step s710, obtain an input image at a first resolution. This may be obtained by generation (e.g. in the case of a video game) or by access from storage or a stream (e.g. in the case of streamed game, TV or film content, or stored TV or film content), as described elsewhere herein.

In a second step s720, pre-process the input image to generate pre-processed input data, and as described elsewhere herein, the input image has a data structure comprising a pixel count ‘C’ and a channel depth ‘d’, and the pre-processing step comprises an inverse pixel shuffling ‘pixel unshuffle’ that reduces the spatial resolution of the data structure whilst increasing the channel depth of the data structure, by reallocating pixel data of one or more first subsets of pixels of the input image to additional channel data of a second subset of pixels of the input image to generate pre-processed input data with a data structure comprising a pixel count of C/R and a channel depth of d×R, where R is a degree of spatial reduction.

In a third step s730, extract deep features based upon the pre-processed input data using one or more convolutional neural network ‘CNN’ blocks, as described elsewhere herein; and In a fourth step s740, generate as an output image an upscaled version of the input image at a second resolution higher than the first resolution, based upon the extracted deep features.

It will be apparent to a person skilled in the art that variations in the above method corresponding to operation of the various embodiments of the apparatus as described and claimed herein are considered within the scope of the present invention, including but not limited to that:

The method comprises the step of extracting shallow features based upon the pre-processed input data using one or more CNN blocks, and wherein the step of extracting deep features based upon the pre-processed input data is based at least in part upon the extracted shallow features themselves based upon the pre-processed input data, as described elsewhere herein;
The method comprises the steps of extracting high frequency features based upon the input image, separately pre-processing the extracted high frequency features using the pixel unshuffled, and extracting high frequency shallow features based upon the pre-processed high frequency features using one or more CNN blocks, as described elsewhere herein;
Alternatively to the above, the method comprises the steps of extracting high frequency features based upon the pre-processed input data, and extracting high frequency shallow features based upon the extracted high frequency features using one or more CNN blocks, as described elsewhere herein;
In either of the above two alternatives, optionally separately extracting high frequency deep features from the extracted high frequency shallow features, as described elsewhere herein;
Similarly in either of the above two alternatives, optionally separately extracting low frequency deep features from low frequency features, and subsequently generating the output image based upon a combination of the extracted high frequency deep features and low frequency deep features, as described elsewhere herein;
At least a first CNN block comprised three trained CNN layers and these have been replaced with a re-parameterised CNN block comprising a single layer generated from the three trained CNN layers, to use during inference, as described elsewhere herein;
In this instance, optionally the three trained CNN layers comprise a 1×1 kernel convolution, a 3×3 kernel convolution, and then a 1×1 kernel convolution, and the re-parameterised CNN block comprises a single 3×3 kernel convolution computed from the three trained CNN layers, as described elsewhere herein;
at least a first CNN block is trained on input data from content specific to one or more selected from the list consisting of a genre, a series, a title, and a scene, level, or region of a title, as described elsewhere herein; and
In this instance, optionally weights corresponding to a relevant trained CNN block are selected and used when the specific content is to be upscaled, as described elsewhere herein.

It will be appreciated that the above methods may be carried out on conventional hardware suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.
Accordingly, in another summary embodiment of the present description, an image upscaling apparatus (for example an entertainment device 10 such as a PlayStation 5® or similar console) comprises the following.
An input image generation processor (for example CPU 20 and/or GPU 30) adapted (for example by suitable software instruction) to obtain an input image at a first resolution, as described elsewhere herein;
a pre-processor (for example CPU 20 and/or GPU 30) adapted (for example by suitable software instruction) to pre-process the input image to generate pre-processed input data, as described elsewhere herein;
one or more convolutional neural network ‘CNN’ blocks (for example defined by software and run on CPU 20 and/or GPU 30, or implemented in a neural processing co-processor, not shown) adapted (for example by suitable software instruction) to extract deep features based upon the pre-processed input data, as described elsewhere herein; and
an image processor (for example CPU 20 and/or GPU 30) adapted (for example by suitable software instruction) to generate as an output image an upscaled version of the input image at a second resolution higher than the first resolution based upon the extracted deep features, as described elsewhere herein; and
wherein the input image has a data structure comprising a pixel count ‘C’ and a channel depth ‘d’, and the pre-processor is adapted (for example by suitable software instruction) to perform an inverse pixel shuffling ‘pixel unshuffle’ that reduces the spatial resolution of the data structure whilst increasing the channel depth of the data structure, by reallocating pixel data of one or more first subsets of pixels of the input image to additional channel data of a second subset of pixels of the input image to generate pre-processed input data with a data structure comprising a pixel count of C/R and a channel depth of d×R, where R is a degree of spatial reduction, as described elsewhere herein.

Instances of this summary embodiment implementing the methods and techniques described herein (for example by use of suitable software instruction) are envisaged within the scope of the application, including but not limited to that:
the apparatus similarly comprises one or more convolutional neural network ‘CNN’ blocks adapted to extract shallow features based upon the preprocessed image, and extracting deep features is based at least in part upon the extracted shallow features, as described elsewhere herein;
the apparatus comprises a high frequency extraction processor adapted to extract high frequency features based upon one of the input image data and the pre-processed input data, and wherein one or more convolutional neural network ‘CNN’ blocks are adapted to extract high frequency shallow features based upon the high frequency features, as described elsewhere herein; and
at least a first CNN block comprised three trained CNN layers and these have been replaced with a re-parameterised CNN block comprising a single layer generated from the three trained CNN layers, to use during inference, as described elsewhere herein.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method of image upscaling, comprising the steps of:
obtaining an input image at a first resolution;
pre-processing the input image to generate pre-processed input data;
extracting deep features based upon the pre-processed input data using one or more convolutional neural network ‘CNN’ blocks; and
generating as an output image an upscaled version of the input image at a second resolution higher than the first resolution based upon the extracted deep features;
wherein the input image has a data structure comprising a pixel count ‘C’ and a channel depth ‘d’, and the pre-processing step comprises an inverse pixel shuffling ‘pixel unshuffle’ that reduces the spatial resolution of the data structure whilst increasing the channel depth of the data structure, by reallocating pixel data of one or more first subsets of pixels of the input image to additional channel data of a second subset of pixels of the input image to generate pre-processed input data with a data structure comprising a pixel count of C/R and a channel depth of d×R, where R is a degree of spatial reduction.

2. The method of claim 1, comprising the step of:
extracting shallow features based upon the pre-processed input data using one or more CNN blocks; and wherein
the step of extracting deep features based upon the pre-processed input data is based at least in part upon the extracted shallow features themselves based upon the pre-processed input data.

3. The method of claim 1, comprising the steps of:
extracting high frequency features based upon the input image;
separately pre-processing the extracted high frequency features using the pixel unshuffle; and
extracting high frequency shallow features based upon the pre-processed high frequency features using one or more CNN blocks.

4. The method of claim 1, comprising the steps of:
extracting high frequency features based upon the pre-processed input data; and
extracting high frequency shallow features based upon the extracted high frequency features using one or more CNN blocks.

5. The method of claim 4, comprising the step of:
separately extracting high frequency deep features from the extracted high frequency shallow features.

6. The method of claim 5, comprising the step of:
separately extracting low frequency deep features from low frequency features; and
subsequently generating the output image based upon a combination of the extracted high frequency deep features and low frequency deep features.

7. The method of claim 1, in which:
at least a first CNN block comprised three trained CNN layers and these have been replaced with a re-parameterised CNN block comprising a single layer generated from the three trained CNN layers, to use during inference.

8. The method of claim 7, in which the three trained CNN layers comprise a 1×1 kernel convolution, a 3×3 kernel convolution, and then a 1×1 kernel convolution, and the re-parameterised CNN block comprises a single 3×3 kernel convolution computed from the three trained CNN layers.

9. The method of claim 1 in which at least a first CNN block is trained on input data from content specific to one or more selected from the list consisting of:
i. a genre;
ii. a series;
iii. a title; and
iv. a scene, level, or region of a title.

10. The method of claim 9, in which weights corresponding to a relevant trained CNN block are selected and used when the specific content is to be upscaled.

11. A non-transitory, computer readable storage medium containing a computer program comprising computer executable instructions that when executed by computer system, cause the computer system to perform a method of image upscaling, comprising the steps of:
obtaining an input image at a first resolution;
pre-processing the input image to generate pre-processed input data;
extracting deep features based upon the pre-processed input data using one or more convolutional neural network ‘CNN’ blocks; and
generating as an output image an upscaled version of the input image at a second resolution higher than the first resolution based upon the extracted deep features;
wherein the input image has a data structure comprising a pixel count ‘C’ and a channel depth ‘d’, and the pre-processing step comprises an inverse pixel shuffling ‘pixel unshuffle’ that reduces the spatial resolution of the data structure whilst increasing the channel depth of the data structure, by reallocating pixel data of one or more first subsets of pixels of the input image to additional channel data of a second subset of pixels of the input image to generate pre-processed input data with a data structure comprising a pixel count of C/R and a channel depth of d×R, where R is a degree of spatial reduction.

12. An image upscaling apparatus, comprising:
an input image generation processor adapted to obtaining an input image at a first resolution;
a pre-processor adapted to pre-process the input image to generate pre-processed input data;
one or more convolutional neural network ‘CNN’ blocks adapted to extract deep features based upon the pre-processed input data; and
an image processor adapted to generate as an output image an upscaled version of the input image at a second resolution higher than the first resolution based upon the extracted deep features;
wherein the input image has a data structure comprising a pixel count ‘C’ and a channel depth ‘d’, and the pre-processor is adapted to perform an inverse pixel shuffling ‘pixel unshuffle’ that reduces the spatial resolution of the data structure whilst increasing the channel depth of the data structure, by reallocating pixel data of one or more first subsets of pixels of the input image to additional channel data of a second subset of pixels of the input image to generate pre-processed input data with a data structure comprising a pixel count of C/R and a channel depth of d×R, where R is a degree of spatial reduction.

13. The image upscaling apparatus of claim 12, comprising:
one or more convolutional neural network ‘CNN’ blocks adapted to extract shallow features based upon the pre-processed input image; and wherein
the step of extracting deep features is based at least in part upon the extracted shallow features.

14. The image upscaling apparatus of claim 12, comprising:
a high frequency extraction processor adapted to extract high frequency features based upon one of the input image data and the pre-processed input data; and wherein
one or more convolutional neural network ‘CNN’ blocks are adapted to extract high frequency shallow features based upon the high frequency features.

15. The image upscaling apparatus of claim 12, in which at least a first CNN block comprised three trained CNN layers and these have been replaced with a re-parameterised CNN block comprising a single layer generated from the three trained CNN layers, to use during inference.

16. The method of claim 3, comprising the step of:
separately extracting high frequency deep features from the extracted high frequency shallow features.
